(19) United States
(12) Patent Application Publication
(10) Pub. No.: US 2020/0247051 A1
(43) Pub. Date: Aug. 6, 2020

(54) THREE-DIMENSIONAL FORMING DEVICE

(71) Applicants: XYZPRINTING, INC., New Taipei City (TW); KINPO ELECTRONICS, INC., New Taipei City (TW)

(72) Inventors: Wei-Chun JAU, NEW TAIPEI CITY (TW); Tsung-Hua KUO, NEW TAIPEI CITY (TW)

(21) Appl. No.: 16/456,989

(22) Filed: Jun. 28, 2019

(30) Foreign Application Priority Data
Jan. 31, 2019 (CN) 201910099978.0

(51) Int. Cl. B29C 64/255; B29C 64/245; B29C 64/264

(52) U.S. Cl. CPC B29C 64/255; B33Y 30/00; B29C 64/264; B29C 64/245

(57) ABSTRACT

A rapid forming three-dimensional forming device having a forming tank, a forming platform, an elevating mechanism and an illumination module is provided. The forming tank has a base, an annular wall and an oxygen permeable file. An open chamber is defined in the base. The annular wall is arranged on the base. The oxygen permeable file is arranged on a lower edge of the annular wall to closes a bottom of the annular wall and to expose within the open chamber. An expansion frame is arranged on the oxygen permeable file corresponding to an area defined in the annular wall. The elevating mechanism could move the forming platform relative to the oxygen permeable file. The illumination module is arranged aligning to a forming platform and under the oxygen permeable file for projecting a light to where between the forming platform and the oxygen permeable file through the oxygen permeable file.

### BACKGROUND OF THE INVENTION

### Technical Field

The present disclosure is related to a three-dimensional forming device, and in particular to a rapid forming three-dimensional forming device.

### Description of Related Art

A forming method of a stereolithography printer (SLA 3D printer) is to project a UV light to a predetermined area of a forming liquid (UV resin) contained in a tank. Thereby a layer piece is solidified in the area of the forming liquid. Another layer piece could be stacked on the solidified layer piece by repeat the aforementioned step, and the model could be formed by the stack of layer piece. A conventional stereolithography printer could be bottom up type or top down type according to a projecting direction of UV light projected by the stereolithography printer.

The present disclosure is related to a bottom up type printer, the tank of the bottom up type printer should be light transmissive, a forming liquid contained in the tank could be projected by a UV light projected from a UV source arranged under the tank. The bottom up type printer includes a forming platform arranged over the tank, the forming platform is descended into the forming liquid and a slim gap is thereby maintained between the forming platform and a bottom of the tank. The UV light is projected to a predetermined area on the forming platform, and the forming liquid in the area and between the forming platform and the bottom of the tank is thereby solidified to form a layer piece. Then, the forming platform is lifted, and a slim gap is thereby formed between the aforementioned layer piece and the bottom of the tank for solidifying another layer piece. The layer piece is easy to be stuck on the bottom of the tank, and the forming platform therefore cannot be rapidly lifted. Therefore, a special cover is coated in on the bottom of the tank to make it easier to remove the layer piece from the bottom. A bottom of a conventional top down type tank is usually covered by a Teflon film.

The Teflon film has good resistance of tensile strength, and a glass plate is generally used as the bottom of the tank under the Teflon film to support and tight the Teflon film. Teflon is pulled up when a layer piece is solidified and the platform is lifted, because the layer piece is bonded with the Teflon film. Therefore, the forming platform should be moved up and down to remove the object from the Teflon film. Accordingly, printing time is increased and the printer cannot print rapidly.

Silicone materials are soft, and an acrylic plate is generally used as the bottom of the tank. A liquid silicone is poured onto the acrylic plate and cured to form a silicone film. oxygen can infiltrate silicone and can be absorb by silicone, oxygen is released into the sink and an oxygen suppression layer is formed on the surface of the silicone film during a printing process. The oxygen suppression layer decreases a stickiness between the layer piece and the silicone film and they are therefore easy to be separated. A series of related studies were conducted by Dr. Doyle group of the Massachusetts Institute of Technology (MIT), and the first report about speeding up curing process of photocurable resins by oxygen suppression layer was published on Nature Materials Letters in April 2006. A simulation by calculation method about determining a distribution of oxygen diffused into a device from the atmosphere via Polydimethylsiloxane (PDMS) was then published on Macromolecules in October 2008.

“Synthesis of biomimetic oxygen-carrying compartmentalized microparticles using flow lithography” written by Dr. Doyle group was published on Lab on a Chip 13.24 (2013): 4765-4774. This paper recited that oxygen could be dissolved in Fluorocarbons (PFC) added in the photocurable resins. It has been found according to experiment that the higher the oxygen content is, thicker the thickness of the oxygen suppression layer is. Fluoride leads to a worse accuracy of curing process, and the curing time therefore becomes long. According to this research, inert gas added in the tank leads to better accuracy of curing process. The inert gas also decreases the content of oxygen in the fluorocarbon, and leads to better accuracy of curing process. The lower the concentration of oxygen in the tank is, the less the thickness of the oxygen suppression layer is. The effects of oxygen concentration on the thickness of the oxygen suppression layer and solidification were discussed in this paper. However, atmosphere was applied rather than high concentration oxygen, so the maximum oxygen concentration is 21%.

An article written by Dr. Doyle group about controlling print quality by oxygen concentration was published on Soft Material in Jul. 2014. In Oct. 2014, “Stop Flow Lithography in Perfluoropolyether (PFPE) Microfluidic Channels” was published on Lab on a Chip 14.24 (2014): 4680-4687. This article described that the Perfluoropolyether (PFPE) is substituted by Polydimethylsiloxane (PDMS). Polydimethylsiloxane is easy to react with organic solvents, but perfluoropolyether is soft and has a lower oxygen permeability.

A technical solution for avoiding cured layer piece from sticking on PDMS by the oxygen suppression layer piece was proposed in US 2013/0295212 A1. oxygen is consumed during chemical reaction with the photocurable resin. Therefore, silicone should be exposed in atmosphere after curing process of each layer piece, and oxygen could be absorbed by the silicone. For example, according to US 2013/0295212 A1, the photocurable resin on at least a part of the silicone is temporarily scraped out between sequential curing procedures for exposing the silicone in atmosphere to absorb oxygen. This solution leads to increase of printing time. In order to print rapidly, oxygen should infiltrate into the tank through the bottom of the tank. However, oxygen can infiltrate through neither glass nor Acrylic, oxygen therefore cannot infiltrate into the tank through the bottom of the tank. The patent CN105122135A and WO2014126837A3 of Carbon 3D recite that a dead zone with specific thickness could be formed on the silicone film by supplying pressured oxygen to where under the silicone film. The forming liquid in the dead zone cannot be cured, the layer pieces are thereby separated from the silicone film, and the printer can print rapidly. However, the film is bent by expansion of pressured air and weight change of the forming liquid in the tank, the film might be bent when a balance between the pressure and the weight is changed. Each layer piece formed on an uneven file is also uneven, and a model formed by a stack of the layer pieces will be incorrect.

In views of this, in order to solve the above disadvantage, the present inventor studied related technology and provided a reasonable and effective solution in the present disclosure.

### SUMMARY OF THE INVENTION

A rapid forming three-dimensional forming device and a forming tank thereof are provided in the present disclosure.

According to an embodiment of the present disclosure, the forming tank has a base, an annular wall and an oxygen permeable file. An open chamber is defined in the base. The annular wall is arranged on the base. The oxygen permeable file is disposed in a horizontal arrangement and fixed on a lower edge of the annular wall. A bottom of the annular wall is closed by the oxygen permeable file and the oxygen permeable file is exposed within the open chamber. An expansion frame is arranged on the oxygen permeable file. The expansion frame is arranged corresponding to an area defined in the annular wall. The expansion frame presses on the oxygen permeable file at a plurality of portions along a direction perpendicular to the oxygen permeable file and the oxygen permeable file is thereby flatten.

According to the embodiment of the present disclosure, the expansion frame is accommodated in the annular wall and downward exceeds the lower edge of the annular wall to downward press on the oxygen permeable file. The expansion frame is arranged under the annular wall and upward extended into the annular wall to upward press on the oxygen permeable file. A peripheral edge of the oxygen permeable file is clamped between the lower edge of the annular wall and the expansion frame. The expansion frame is accommodated in the open chamber of the base. The expansion frame is annular-shaped and a plurality of through holes are defined on a lateral surface of the expansion frame.

According to the embodiment of the present disclosure, the peripheral edge of the oxygen permeable file in the forming tank is fixed on the lower edge of the annular wall. The base has a fastening ring, the fastening ring is telescoped with the annular wall, and the peripheral edge of the oxygen permeable file is clamped between the lower edge of the annular wall and the fastening ring.

According to the embodiment of the present disclosure, three-dimensional forming device has aforementioned forming tank, a forming platform, an elevating mechanism and an illumination module. The forming platform is hung over the forming tank and arranged downward aligning to an area defined within the annular wall. The elevating mechanism is connected to the forming platform for moving the forming platform relative to the oxygen permeable file. The illumination module is arranged aligning to a forming platform and under the oxygen permeable file for projecting a light to where between the forming platform and the oxygen permeable file through the oxygen permeable file.

According to the embodiment of the present disclosure, the expansion frame of the three-dimensional forming device is accommodated in the annular wall and downward exceeds the lower edge of the annular wall to downward press on the oxygen permeable file. The expansion frame is arranged under the annular wall and upward extended into the annular wall to upward press on the oxygen permeable file. A peripheral edge of the oxygen permeable file is clamped between the lower edge of the annular wall and the expansion frame. the expansion frame is accommodated in the open chamber of the base. the expansion frame is annular-shaped and a plurality of through holes are defined on a lateral surface of the expansion frame.

According to the embodiment of the present disclosure, the oxygen permeable file of the three-dimensional forming device is fixed on the lower edge of the annular wall. the base comprises a fastening ring, the fastening ring is telescoped with the annular wall, and the peripheral edge of the oxygen permeable file is clamped between the lower edge of the annular wall and the fastening ring.

According to the embodiment of the present disclosure, the three-dimensional forming device further comprising an oxygen supplying module communicated with the open chamber. The illumination module is arranged under the base and the bass is light transmissive. The illumination module is arranged in the open chamber. The oxygen permeable file could be a silicone film.

### BRIEF DESCRIPTION OF DRAWING

The present disclosure can be more fully understood by reading the following detailed description of the embodiment, with reference made to the accompanying draw.

FIGS. 1 and 2 are schematic views showing the three-dimensional forming device according to a preferred embodiment of the present disclosure.

FIG. 3 is a schematic view showing the three-dimensional forming device in operation according to the preferred embodiment of the present disclosure.

FIG. 4 is a schematic view showing another arrangement of the expansion frame of the three-dimensional forming device according to the preferred embodiment of the present disclosure.

FIG. 5 is a schematic view showing another arrangement of the oxygen permeable file of the three-dimensional forming device according to the preferred embodiment of the present disclosure.

FIG. 6 is a schematic view showing another arrangement of the illumination module of the three-dimensional forming device according to the preferred embodiment of the present disclosure.

### DETAILED DESCRIPTION OF THE INVENTION

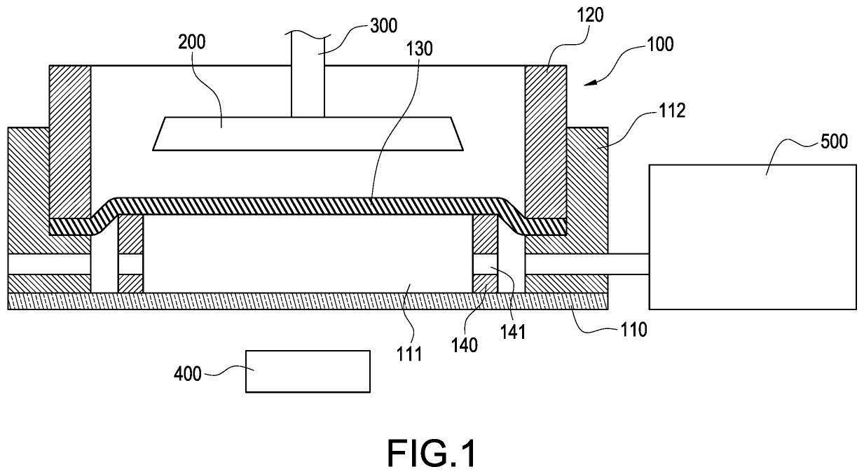

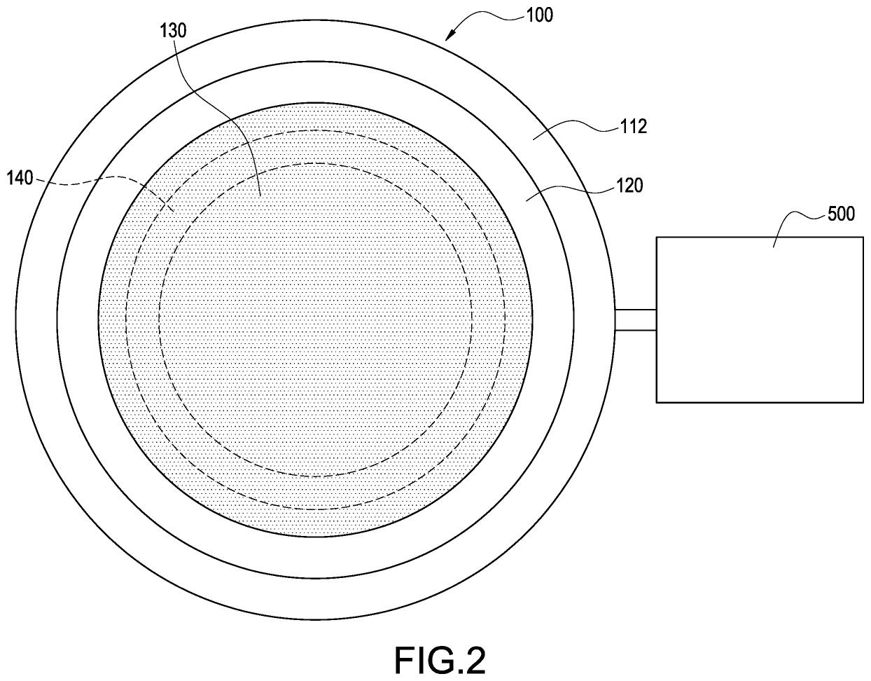

According to FIGS. 1 to 3, an embodiment showing a three-dimensional forming device having a forming tank 100, a forming platform 200, an elevating mechanism 300 and an illumination module 400 is provided in the present disclosure.

The forming tank 100 is used for containing a forming liquid 10. Generally, the forming liquid 10 is a UV resin, and the forming liquid 10 is cured when exposed under a UV light. According to the present embodiment, the forming tank 100 has a base 110, an annular wall 120 and an oxygen permeable file 130. An open chamber 111 is defined in the base 110, the annular wall 120 is arranged on the base 110, the oxygen permeable file 130 is disposed in a horizontal arrangement and fixed on a lower edge of the annular wall 120. The oxygen permeable file is preferably a silicone film. Specifically, a peripheral edge of the oxygen permeable file 130 is fixed on the lower edge of the annular wall 120. A bottom of the annular wall 120 is closed by the oxygen permeable file 130 and a bottom surface of the oxygen permeable file 130 is exposed within the open chamber 111 for contacting with oxygen.

The base 110 could selectively further have a fastening ring 112, the fastening ring 112 is telescoped with the annular wall 120. A peripheral edge of the oxygen permeable file 130 is clamped between the lower edge of the annular wall 120 and the fastening ring 112. Thereby, the peripheral edge of the oxygen permeable file 130 is fixed on the lower edge of the annular wall 120. According to the present embodiment, specifically, the fastening ring 112 preferably sleeves the annular wall 120, a lower edge of the fastening ring 112 is converged to cover the lower edge of the annular wall 120, and the peripheral edge of the oxygen permeable file 130 is clamped between the lower edge of the annular wall 120 and the lower edge of the fastening ring 112.

According to the present embodiment, an expansion frame 140 is arranged on the oxygen permeable file 130, the expansion frame 140 is arranged aligning to an area defined within the annular wall 120, and the expansion frame 140 presses on the oxygen permeable file 130 at a plurality of portions along a direction perpendicular to the oxygen permeable file 130 and the oxygen permeable file 130 is thereby flatten. Details of the expansion frame 140 are described below. Specifically, the expansion frame 140 is preferably annular-shaped but should not be limited to be annular-shaped. For example, the expansion frame 140 could be a rectangular ring or an annular ring, and a plurality of through holes 141 are defined on a lateral surface of the expansion frame 140. According to the present embodiment, the expansion frame 140 is preferably arranged under the annular wall 120 and thereby accommodated in the open chamber 111 of the base 110, and an upper edge of the expansion frame 140 is upward extended into the annular wall 120 to upward press on a lower surface of the oxygen permeable file 130 along a direction perpendicular to the oxygen permeable file 130. oxygen could flow through the through hole 141 on the lateral surface of the expansion frame 140 to contact the lower surface of the oxygen permeable file 130.

The forming platform 200 is hung above the forming tank 100 and arranged downward aligning to an area defined within the annular wall 120. The elevating mechanism 300 connected to the forming platform 200 for moving the forming platform 200 relative to the oxygen permeable file 130.

The illumination module 400 is arranged aligning to a forming platform 200 and under the oxygen permeable file 130 for projecting a light to where between the forming platform 200 and the oxygen permeable file 130 through the oxygen permeable file 130. Specifically, the light projected by the illumination module 400 is a UV light. According to the present embodiment, the illumination module 400 is preferably arranged under the base 110 and the base 110 is light transmissive. Thereby, the illumination module 400 is able to project the light to where between the forming platform 200 and the oxygen permeable file 130 through the base 110 and the oxygen permeable file 130.

According to the present embodiment, the three-dimensional forming device of the present disclosure could be selectively further having an oxygen supplying module 500. The oxygen supplying module 500 is communicated with the open chamber 111. The oxygen supplying module 500 generates oxygen and supplies air containing a predetermined ratio of oxygen through the open chamber 111. However, the scope of the present disclosure should not be limited to the present embodiment, oxygen alternatively could be supplied from environment atmosphere in the open chamber 111 if the oxygen supplying module 500 is not available.

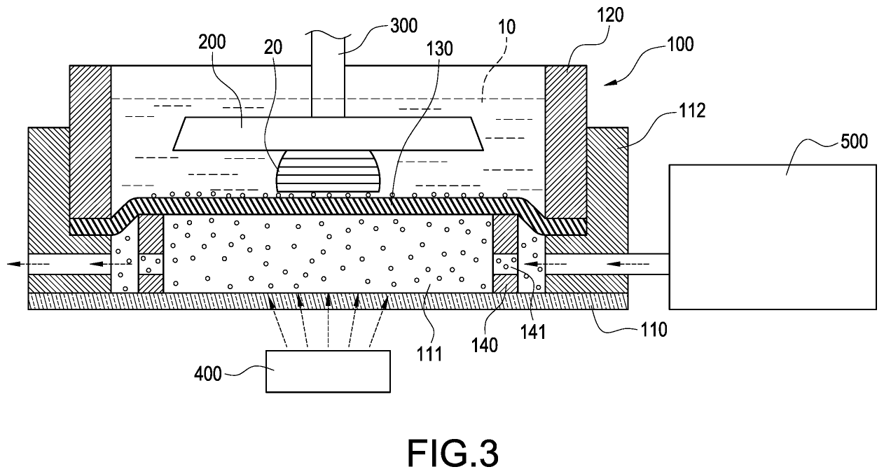

According to the three-dimensional forming device of the present disclosure in operation shown in FIG. 3, oxygen distributed on an upper surface of the oxygen permeable file 130 is reacted with the forming liquid 10 and the forming liquid 10 is thereby prevented from solidifying. Thereby, the forming liquid 10 contacted with the upper surface of the oxygen permeable file 130 is not able to solidify, and the solidified layer piece 20 in the forming liquid 10 is prevented from stuck on the upper surface of the oxygen permeable file 130. Therefore, the forming platform 200 could be immediately lift by the elevating mechanism 300 to next predetermined position for forming after the layer piece 20 is solidified. Repeatedly elevating and swaying for remove the layer piece 20 from the oxygen permeable file 130 is not necessary. When the oxygen distributed on the upper surface of the oxygen permeable file 130 is reacted with the forming liquid 10 and consumed, the oxygen contained in the oxygen permeable file 130 naturally spreads toward the upper surface of the oxygen permeable file 130 containing less oxygen, and oxygen could be continuously absorbed from the open chamber 111 via the lower surface of the oxygen permeable file 130. The expansion frame 140 could flat the oxygen permeable file 130.

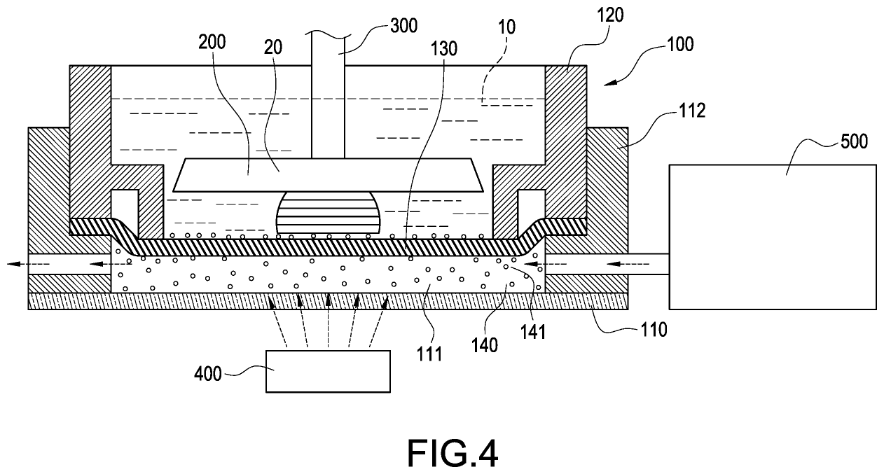

According to another arrangement of the expansion frame 140 shown in FIG. 4, the expansion frame 140 could be contained in the annular wall 120, and the expansion frame 140 downward exceeds the lower edge of the annular wall 120 to downward press on the oxygen permeable file 130 along a direction perpendicular to the oxygen permeable file 130.

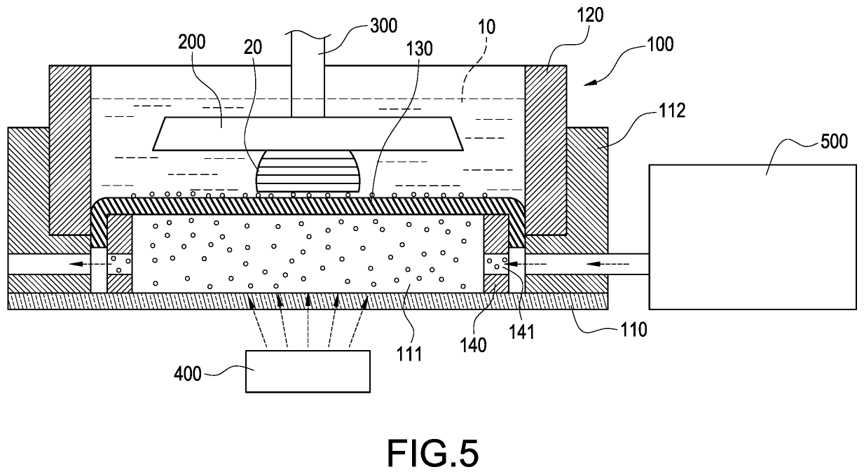

According to another arrangement of the oxygen permeable file 130 shown in FIG. 5, the expansion frame 140 could be inserted in the lower edge of the annular wall 120. According to the present arrangement, the peripheral edge of the oxygen permeable file 130 is clamped and fasten between the lower edge of the annular wall 120 and the expansion frame 140 rather than fasten by the fastening ring 112 of the base 110. Meanwhile, the oxygen permeable file 130 is expanded and thereby flatten.

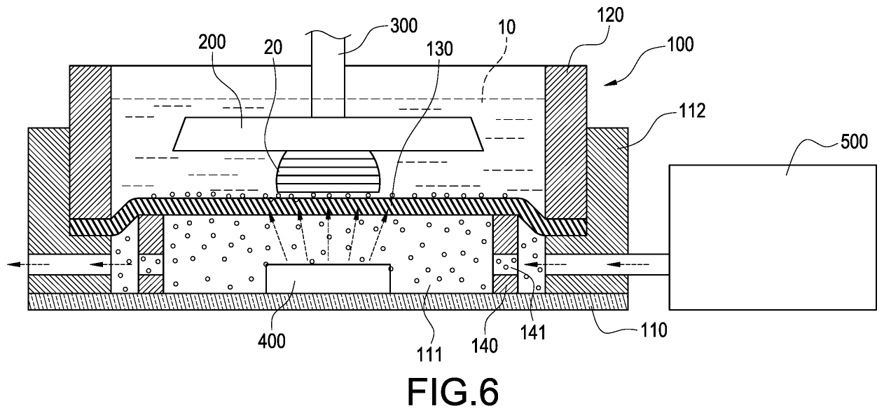

According to another arrangement of the illumination module 400 FIG. 6, the illumination module 400 could be arranged in the open chamber 111.

Although the present disclosure has been described with reference to the foregoing preferred embodiment, it will be understood that the disclosure is not limited to the details thereof. Various equivalent variations and modifications can still occur to those skilled in this art in view of the teachings of the present disclosure. Thus, all such variations and equivalent modifications are also embraced within the scope of the present disclosure as defined in the appended claims.

What is claimed is:

1. A forming tank, comprising a base, an annular wall and an oxygen permeable file, an open chamber being defined in the base, the annular wall being arranged on the base, the oxygen permeable file being disposed in a horizontal arrangement and fixed on a lower edge of the annular wall, a bottom of the annular wall being closed by the oxygen permeable file and the oxygen permeable file being exposed within the open chamber, an expansion frame being arranged on the oxygen permeable file, the expansion frame being arranged corresponding to an area defined in the annular wall, wherein the expansion frame presses on the oxygen permeable file at a plurality of portions along a direction perpendicular to the oxygen permeable file and the oxygen permeable file is thereby flattened.

2. The forming tank according to claim 1, wherein the expansion frame is accommodated in the annular wall and downward exceeds the lower edge of the annular wall to downward press on the oxygen permeable file.

3. The forming tank according to claim 1, wherein the expansion frame is arranged under the annular wall and upward extended into the annular wall to upward press on the oxygen permeable file.

4. The forming tank according to claim 3, wherein a peripheral edge of the oxygen permeable file is clamped between the lower edge of the annular wall and the expansion frame.

5. The forming tank according to claim 3, wherein the expansion frame is accommodated in the open chamber of the base.

6. The forming tank according to claim 5, wherein the expansion frame is annular-shaped and a plurality of through holes are defined on a lateral surface of the expansion frame.

7. The forming tank according to claim 1, wherein the oxygen permeable file is fixed on the lower edge of the annular wall.

8. The forming tank according to claim 7, wherein the base comprises a fastening ring, the fastening ring is telescoped with the annular wall, and the peripheral edge of the oxygen permeable file is clamped between the lower edge of the annular wall and the fastening ring.

9. A three-dimensional forming device, comprising:
the forming tank according to claim 1;
an elevating mechanism connected to a forming platform for moving the forming platform relative to the oxygen permeable file; and
an illumination module aligning to a forming platform and arranged under the oxygen permeable file for projecting a light to where between the forming platform and the oxygen permeable file through the oxygen permeable file.

10. The three-dimensional forming device according to claim 9, wherein the expansion frame is accommodated in the annular wall and downward exceeds the lower edge of the annular wall to downward press on the oxygen permeable file.

11. The three-dimensional forming device according to claim 9, wherein the expansion frame is arranged under the annular wall and upward extended into the annular wall to upward press on the oxygen permeable file.

12. The three-dimensional forming device according to claim 11, wherein a peripheral edge of the oxygen permeable file is clamped between the lower edge of the annular wall and the expansion frame.

13. The three-dimensional forming device according to claim 11, wherein the expansion frame is accommodated in the open chamber of the base.

14. The three-dimensional forming device according to claim 13, wherein the expansion frame is annular-shaped and a plurality of through holes are defined on a lateral surface of the expansion frame.

15. The three-dimensional forming device according to claim 9, wherein the oxygen permeable file is fixed on the lower edge of the annular wall.

16. The three-dimensional forming device according to claim 15, wherein the base comprises a fastening ring, the fastening ring is telescoped with the annular wall, and the peripheral edge of the oxygen permeable file is clamped between the lower edge of the annular wall and the fastening ring.

17. The three-dimensional forming device according to claim 9, further comprising an oxygen supplying module communicated with the open chamber.

18. The three-dimensional forming device according to claim 9, wherein the illumination module is arranged under the base and the base is light transmissive.

19. The three-dimensional forming device according to claim 9, wherein the illumination module is arranged in the open chamber.

20. The three-dimensional forming device according to claim 1, wherein the oxygen permeable file is a silicone film.
